(19) United States
(12) Patent Application Publication
(10) Pub. No.: US 2009/0226048 A1
(43) Pub. Date: Sep. 10, 2009

(54) Biometric authentication apparatus

(75) Inventor: Keiji Fukuda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/285,422

(22) Filed: Oct. 3, 2008

(30) Foreign Application Priority Data
Mar. 5, 2008 (JP) 2008-055472

(51) Int. Cl. G06K 9/00

(52) U.S. Cl. 382/118

(57) ABSTRACT

A disclosed biometric authentication apparatus includes an authentication data input unit configured to acquire a piece of authentication data from a biological object; an authentication data process unit configured to accumulate one or more pieces of authentication data acquired from the start to end of authentication; a matching unit configured to successively match the pieces of authentication data against reference data, and complete the authentication when at least one of the pieces of authentication data has a degree of similarity reaching or exceeding a predetermined authentication threshold; and a reference data registration process unit configured to, in response to a detection that the authentication has completed after a predetermined period elapsed from the start of the authentication process, make an additional registration in which, among the pieces of authentication data, one piece whose degree of similarity reaches or exceeds a predetermined recognition threshold is additionally registered to the reference data.

### CROSS-REFERENCE TO RELATED APPLICATIONS

This application is based upon and claims the benefit of priority of the prior Japanese Patent Application 2008-055472, filed on Mar. 5, 2008, the entire contents of which are incorporated herein by reference.

### FIELD

The embodiment discussed herein is directed to a biometric authentication apparatus for identifying a person.

### BACKGROUND

FIG. 1 shows an overview of conventional biometric authentication. Authentication data, such as a facial image, is acquired from an authentication data input unit 1, such as a camera, and an authentication unit 2 determines consistency (similarity) by matching the acquired authentication data against reference data preregistered in a reference data storage unit 3 and then outputs a result of the authentication. That is, the authentication is completed if a degree of similarity between the authentication data and the reference data reaches or exceeds a predetermined threshold; and the authentication is regarded as a failure if the degree of similarity is less than the predetermined threshold.

Patent Document 1: Japanese Laid-open Patent Publication No. 2004-157602

Conventionally, biometric authentication is implemented in the above-mentioned manner; however, there is a problem that in actual authentication operations, the authentication accuracy may substantially decrease depending on the authentication environment because the reference data used in the matching is usually acquired and registered in an adequate environment. In the case of a facial image, for example, it is usually the case that a facial image captured using an adequate amount of light is registered as reference data. However, in the case where an authentication operation is carried out, for example, outdoors, a camera may operate under a high-light intensity condition or a low-light intensity condition. As a result, although the face is captured on a screen, sufficient feature extraction cannot be performed since the amount of light is too little or too great, which results in an authentication failure (more specifically, “false rejection” in this case). A false rejection may also occur since the captured facial image deviates from a corresponding registered image due to inadequacy in the distance and/or angle between the camera and the face. In the case of a fingerprint, it is usually the case that an image of a fingerprint taken from a clean finger is registered as reference data. However, if the authentication operation is carried out, for example, in summer, the image may be compromised due to the presence of sweat or oil on the finger tip. As a result, sufficient feature extraction cannot be performed, thereby resulting in a false rejection.

In such cases, the authentication operation may be implemented by lowering the threshold of the degree of similarity. Although this reduces the occurrence of failing to authenticate registered individuals, however, the chances to mistakenly authenticate non-registered people increases, thus raising security problems.

Assume, for example, that face authentication is carried out outdoors and the camera operates under high light intensity. Even though the face is captured on a screen, the authentication may not be implemented due to the intensity of the light. In such a case, what an individual in the authentication operation (hereinafter referred to as “authentication subject”) can do to facilitate the authentication operation is, for example, lift up a hand in front of his/her face to cast a shadow on the face, thereby reducing the light intensity. On the other hand, under low light intensity, the authentication subject may turn himself/herself around to change the body position or move to a well-lighted place.

FIG. 2 shows examples of input image transition during an authentication process of face authentication, with FIG. 2A showing illustrative images captured under high light intensity and FIG. 2B showing illustrative images captured under low light intensity. That is, in FIG. 2A, the transition takes place in the following order: Image a1 in which facial characteristics are beyond all recognition; Image a2 in which the profile of the face can be partially recognized; Image a3 having a contrast problem; Image a4 that is still not fully sufficient for authentication; and Image a5 to be successfully authenticated since it exceeds an authentication threshold. Thus, with Image a5, the authentication is achieved for the first time. Note that in FIG. 2A, a registered image, i.e. reference data, is shown on the far right. Similarly, in FIG. 2B, the transition takes place in the following order: Image b1 in which facial characteristics are beyond all recognition; Image b2 in which the profile of the face can be partially recognized; Image b3 having a contrast problem; Image b4 that is still not fully sufficient for authentication; and Image b5 to be successfully authenticated since it exceeds the authentication threshold. Thus, with Image b5, the authentication is achieved for the first time.

In the case where an authentication operation is often carried out under such a condition, the authentication subject has to make a bodily movement, like one described above, each time in a similar condition. This requires considerable time to complete each authentication operation, and significantly slows down the authentication speed. Furthermore, in an environment where the authentication threshold cannot be reached no matter what bodily movement or positional adjustment may be made by the authentication subject, successful authentication would never be achieved.

Patent Document 1 discloses a person recognition apparatus capable of reducing the false rejection rate against changes in an authentication subject due to aging and variation in input information at the time of authentication. However, according to the structure of the disclosed person recognition apparatus, registered information of the authentication subject is updated using data which has been determined as having a degree of similarity with the registered information, which falls within a predetermined update range. That is, the update is done using data of the authentication subject for which authentication has been successfully achieved. The disclosed technology is indeed effective in the case where characteristics of biometric information themselves change due to aging of the authentication subject. However, since the level of the data used for updating the registered information remains the same, the disclosed technology cannot deal with false rejections due to environmental conditions described above. Accordingly, to lower the threshold of the degree of similarity (i.e. to reduce the authentication accuracy) is the only way to deal with such situations, which results in security problems. Therefore, it is necessary to establish a structure by taking into account the balance between the authentication accuracy and the authentication rate.

### SUMMARY

Accordingly, in view of the problems of the prior art, there is a need to provide a biometric authentication apparatus that improves, without lowering the threshold of the degree of similarity, the authentication accuracy subject to the authentication environment.

According to an aspect of the present disclosure, a biometric authentication apparatus includes an authentication data input unit configured to acquire a piece of authentication data from a biological object; an authentication data process unit configured to accumulate one or more pieces of authentication data acquired from the start to the end of authentication; a matching unit configured to successively match the accumulated pieces of authentication data against reference data, and complete the authentication when at least one of the accumulated pieces of authentication data has a degree of similarity with the reference data, in which the degree of similarity reaches or exceeds a predetermined authentication threshold; and a reference data registration process unit configured to, in response to a detection that the authentication has completed after a predetermined period of time elapsed from the start of the authentication process, make an additional registration in which, among the accumulated pieces of authentication data, one piece of authentication data whose degree of similarity reaches or exceeds a predetermined recognition threshold is additionally registered to the reference data.

Additional objects and advantages of the embodiment will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 shows an overview of conventional biometric authentication;

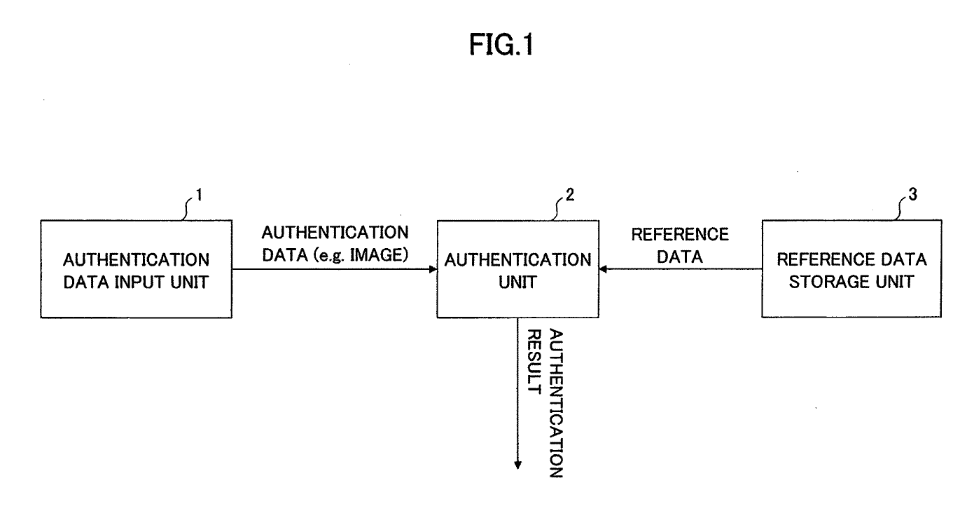

FIGS. 2A and 2B show examples of input image transition during an authentication process;

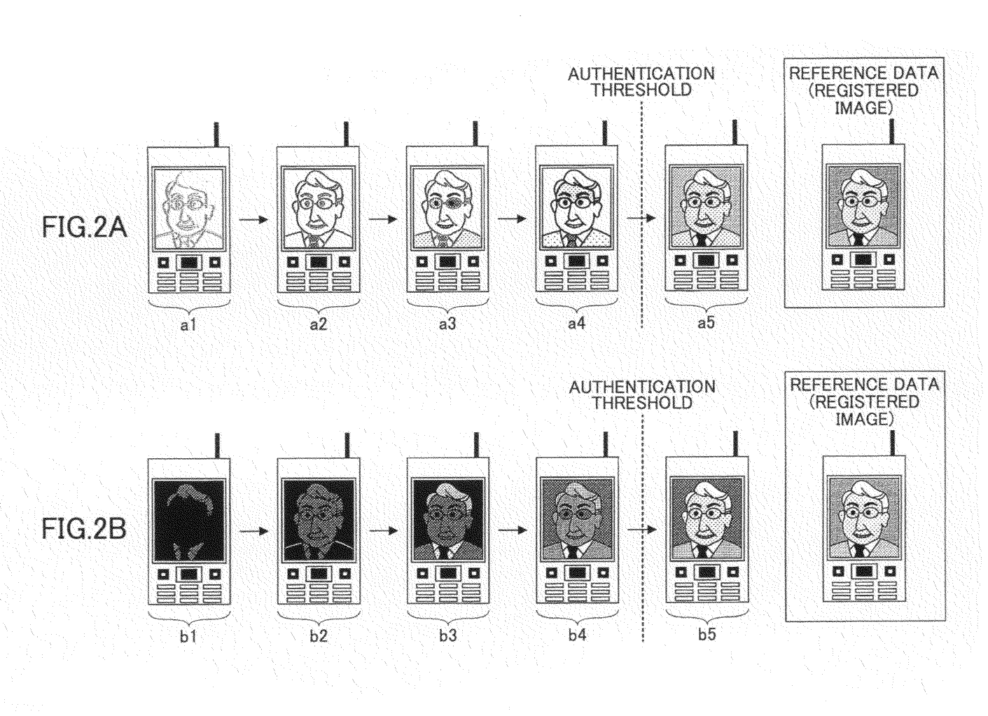

FIG. 3 shows a structural example of a biometric authentication apparatus according to one embodiment of the present disclosure;

FIG. 4 shows an example of a data structure in a preliminary storage subunit;

FIG. 5 shows an example of a data structure in a reference data storage subunit;

FIG. 6 is a flowchart showing a process example according to the present embodiment;

FIG. 7 is an example showing correspondence of the degree of similarity to brightness; and

FIGS. 8A and 8B show examples of input image transition during an authentication process.

### DESCRIPTION OF EMBODIMENT

Next is described a preferred embodiment of the present disclosure.

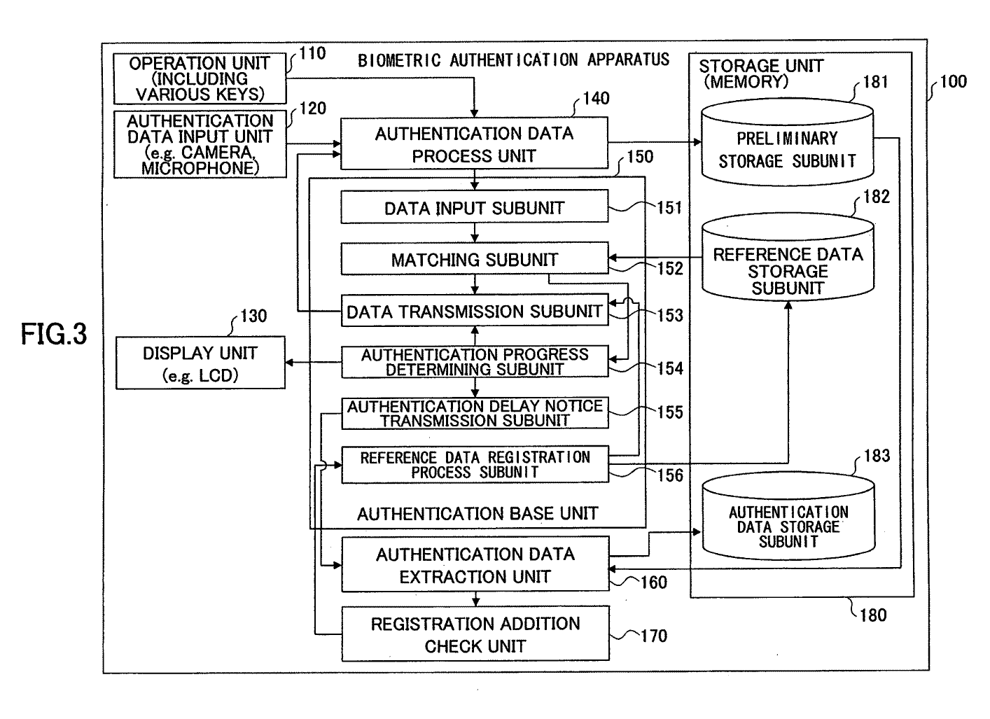

STRUCTURE FIG. 3 shows a structural example of a biometric authentication apparatus according to one embodiment of the present disclosure, and illustrates that the embodiment of the present disclosure is applied to a mobile telephone. Note however that the present disclosure is not limited to mobile telephones, but may also be applied to PCs (Personal Computers) and specialized apparatuses, for example.

In FIG. 3, a biometric authentication apparatus 100 includes an operation unit 110 including various keys and the like; an authentication data input unit 120, such as a camera, or a microphone; a display unit 130 including an LCD (Liquid Crystal Display) and the like; and a storage unit 180, such as memory. The storage unit 180 includes, as data areas, a preliminary storage subunit 181 for storing all pieces of authentication data acquired from the start of the authentication process to the completion of authentication, or until the authentication process is terminated due to time out; a reference data storage subunit 182 for storing reference data to be used for matching in the authentication process; and an authentication data storage subunit 183 for storing pieces of authentication data so as to reuse them for another purpose. The data structures are described later.

The biometric authentication apparatus 100 further includes an authentication data process unit 140. The functions of the authentication data process unit 140 include, for example, starting a process in accordance with a predetermined operation performed on the operation unit 110; acquiring a piece of authentication data, such as an image or voice, from the authentication data input unit 120; accumulating the acquired piece of authentication data in the preliminary storage subunit 181; transmitting the piece of authentication data to an authentication base unit 150 (to be described below); receiving a matching result from the authentication base unit 150; recording the matching result to a corresponding piece of authentication data stored in the preliminary storage subunit 181; and deleting pieces of authentication data stored in the preliminary storage subunit 181.

The authentication base unit 150 which performs a major part of the authentication process includes a data input subunit 151 for inputting a piece of authentication data from the authentication data process unit 140; a matching subunit 152 for determining the degree of similarity by comparing a piece of authentication data acquired via the data input subunit 151 against a piece of reference data prestored in the reference data storage subunit 182, and authenticating the piece of authentication data according to whether or not the degree of similarity reaches or exceeds an authentication threshold; a data transmission subunit 153 for transmitting a matching result and the like to the authentication data process unit 140; an authentication progress determining subunit 154 for determining the progress of the authentication process (e.g. completion of the authentication, time out, and the remaining time until completion of the authentication) performed by the matching subunit 152, and causing the display unit 130 to display the authentication result if needed; an authentication delay notice transmission subunit 155 for transmitting an authentication delay notice to an authentication data extraction unit 160 (to be described below) in the case when the time until completion of the authentication exceeds a predetermined time; and a reference data registration process subunit 156 for registering a piece of reference data in the reference data storage subunit 182 at the time of the initial registration, and in response to a request from a registration addition check unit 170 (to be described below) for an additional registration, and transmitting a request for deleting storage content of the preliminary storage subunit 181 to the authentication data process unit 140 via the data transmission subunit 153 in the case of having made an additional registration in response to the request from the registration addition checking unit 170.

The authentication data extraction unit 160 has a function of extracting pieces of authentication data from the preliminary storage subunit 181 and registering the pieces of authentication data in the authentication data storage subunit 183 in the case of receiving an authentication delay notice from the authentication delay notice transmission subunit 155. The registration addition check unit 170 has a function of identifying, among pieces of authentication data extracted by the authentication data extraction unit 160 from the preliminary storage subunit 181, a piece of authentication data whose degree of similarity reaches or exceeds a predetermined recognition threshold and which has been determined by the user, and requesting the reference data registration process subunit 156 to make an additional registration of the piece of authentication data. The predetermined recognition threshold corresponds to a level enabling minimum feature extraction for the authentication matching.

Note that the authentication data process unit 140, the authentication base unit 150, the authentication data extraction unit 160 and the registration addition check unit 170 are implemented by a computer program executed by a hardware resource, such as a CPU (Central Processing Unit), ROM (Read Only Memory), or RAM (Random Access Memory).

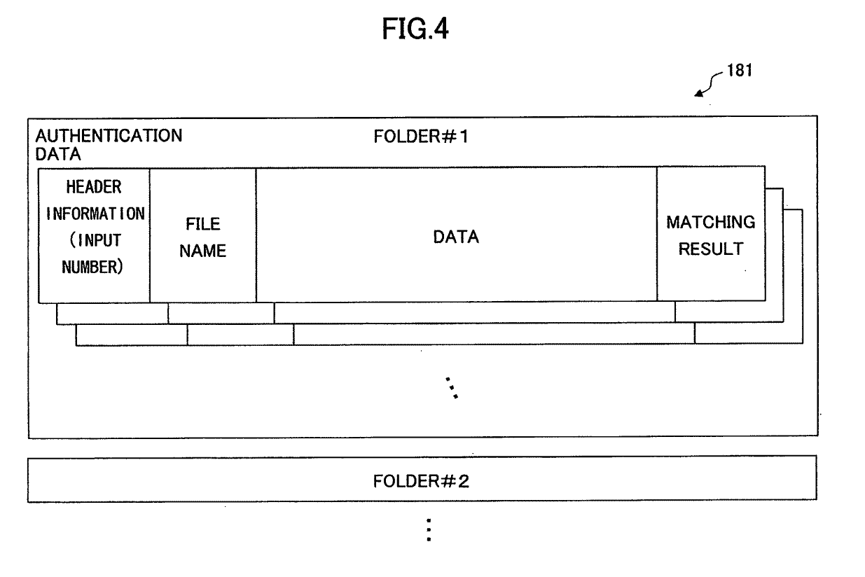

FIG. 4 shows an example of a data structure in the preliminary storage subunit 181. Each piece of authentication data includes header information including an input number that indicates the entry order of the authentication data from the authentication data input unit 120; a file name of the authentication data; a main data portion including image data; and a matching result field including the degree of similarity determined by matching the authentication data against corresponding reference data. The matching result field is blank when the authentication data is first accumulated in the preliminary storage subunit 181. Respective pieces of authentication data are separately stored in multiple folders if needed.

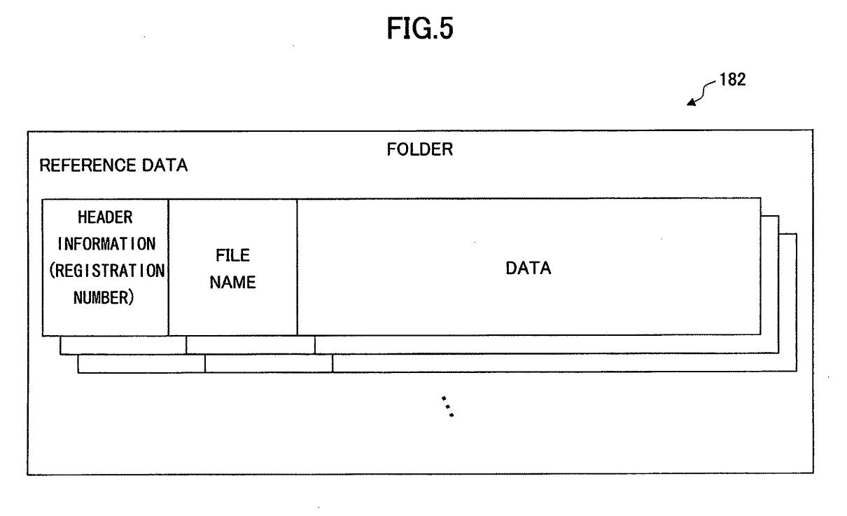

FIG. 5 shows an example of a data structure in the reference data storage subunit 182. Each piece of reference data includes header information including a registration number that indicates the registration order of the reference data; a file name of the reference data; and a main data portion including image data.

Although the data structure in the authentication data storage subunit 183 is not shown, it is the same as that in the preliminary storage subunit 181 illustrated in FIG. 4. Note that since the authentication data storage subunit 183 reuses pieces of authentication data for another purpose, the matching result field may be omitted.

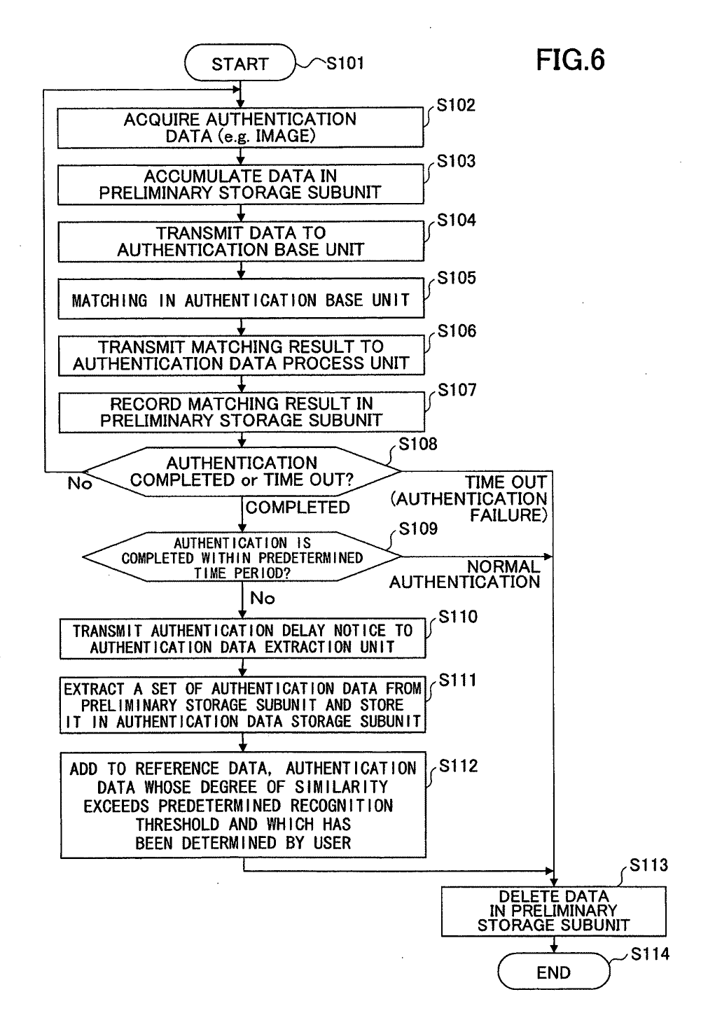

OPERATION FIG. 6 is a flowchart showing a process example according to the present embodiment.

According to FIG. 6, an authentication process starts in response to a predetermined operation on the operation unit 110 (Step S101). The authentication data process unit 140 acquires from the authentication data input unit 120 a piece of authentication data, such as image data or audio data (Step S102), and accumulates the authentication data in the preliminary storage subunit 181 (Step S103) and also transmits the authentication data to the authentication base unit 150 (Step S104).

In the authentication base unit 150, after the data input subunit 151 inputs the piece of authentication data from the authentication data process unit 140, the matching subunit 152 matches the piece of authentication data against a corresponding piece of reference data stored in the reference data storage subunit 182 (Step S105), and the data transmission subunit 153 transmits a matching result to the authentication data process unit 140 (Step S106).

After receiving the matching result from the data transmission subunit 153 of the authentication base unit 150, the authentication data process unit 140 records the matching result in the matching result field of a corresponding piece of authentication data (i.e. a piece of authentication data stored most recently) in the preliminary storage subunit 181 (Step S107).

Next, the authentication progress determining subunit 154 of the authentication base unit 150 determines whether the authentication has completed due to, in the matching performed by the matching subunit 152, the predetermined authentication threshold in the degree of similarity being reached or exceeded, or the authentication process has been terminated due to running out of a predetermined time period (e.g. several tens of seconds) from the start of the process (Step S108). If neither is the case (Step S108: No), the authentication progress determining subunit 154 requests, via the data transmission subunit 153, the authentication data process unit 140 to perform another authentication process for a new piece of authentication data. The authentication data process unit 140 repeats the same procedure from Step S102 in which a new piece of authentication data is acquired.

If the authentication has completed (Step S108: Completed), the authentication progress determining subunit 154 determines whether or not it has completed within a predetermined time period (e.g. three seconds) (Step S109).

If the completion of the authentication took more than the predetermined time period (Step S109: No), i.e. the authentication has completed after the predetermined time period elapsed, the authentication progress determining subunit 154 causes the authentication delay notice transmission subunit 155 to transmit an authentication delay notice to the authentication data extraction unit 160 (Step S110).

Upon receiving the authentication delay notice, the authentication data extraction unit 160 extracts a set of pieces of authentication data from the preliminary storage subunit 181 and stores them in the authentication data storage subunit 183 (Step S111).

Next, the registration addition check unit 170 refers to the matching result field of each piece of authentication data extracted by the authentication data extraction unit 160 from the preliminary storage subunit 181. Herewith, the registration addition check unit 170 determines, among the set of pieces, a piece of authentication data whose degree of similarity reaches or exceeds a predetermined recognition threshold and which has been determined by the user. The predetermined recognition threshold corresponds to a level enabling minimum feature extraction for the authentication matching. Then, the registration addition check unit 170 requests the reference data registration process subunit 156 for an additional registration. In response to the request, the reference data registration process subunit 156 makes an additional registration of the piece of authentication data in the reference data storage subunit 182 (Step S112). A “piece of authentication data which has been determined by the user” is a piece of authentication data acquired, for example, three seconds prior to completion of the authentication in the case where the user has made a setting in advance to make an additional registration of such a piece of authentication data. Instead of having the user make such a setting in advance, pieces of authentication data all having a degree of similarity reaching or exceeding the predetermined recognition threshold may be displayed on the display unit 130 as reduced images or the like, to thereby allow the user to select a piece of authentication data to be additionally registered as a piece of reference data.

After completing the additional registration of the piece of the authentication data in the reference data storage subunit 182, the reference data registration process subunit 156 requests, via the data transmission subunit 153, the authentication data process unit 140 to delete all pieces of authentication data in the preliminary storage subunit 181, which are no longer required. In response to the request, the authentication data process unit 140 deletes the pieces of authentication data from the preliminary storage subunit 181 (Step S113) and then ends the process (Step S114).

On the other hand, if the authentication process has been terminated due to running out of the predetermined time period (Step S108: time out), the authentication progress determining subunit 154 determines it as an authentication failure, and requests, via the data transmission subunit 153, the authentication data process unit 140 to delete all pieces of authentication data in the preliminary storage subunit 181, which are no longer required. In response to the request, the authentication data process unit 140 deletes the pieces of authentication data from the preliminary storage subunit 181 (Step S113) and then ends the process (Step S114).

If the authentication has completed within the predetermined time period (Step S109: Yes), the authentication progress determining subunit 154 determines it as normal authentication, and requests, via the data transmission subunit 153, the authentication data process unit 140 to delete all pieces of authentication data in the preliminary storage subunit 181, which are no longer required. In response to the request, the authentication data process unit 140 deletes the pieces of authentication data from the preliminary storage subunit 181 (Step S113) and then ends the process (Step S114).

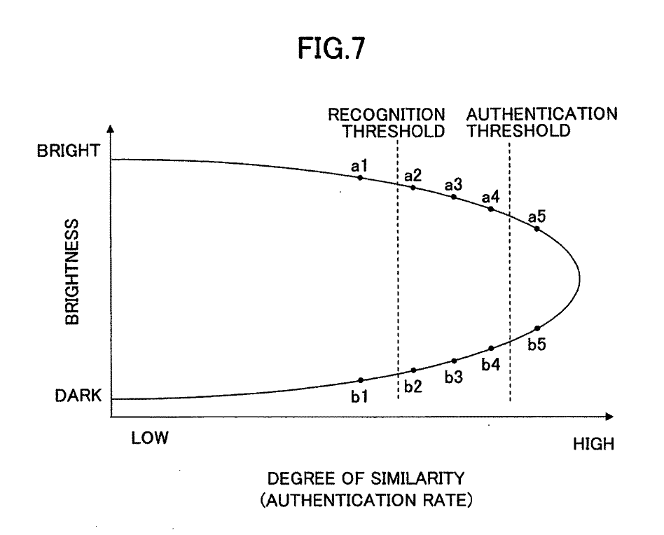

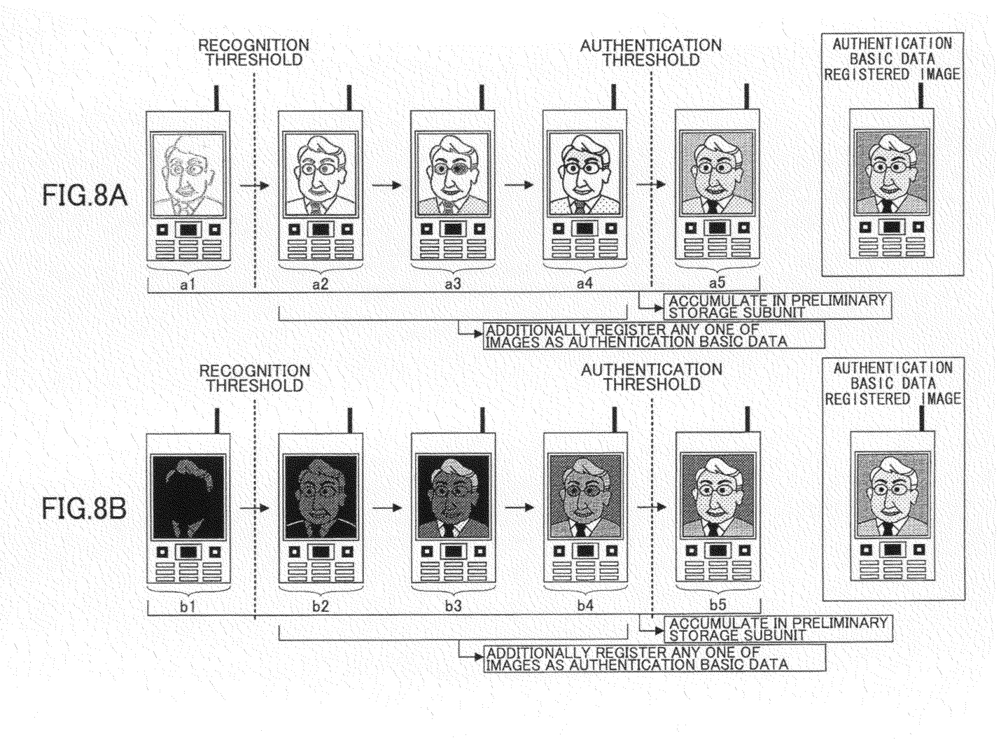

FIG. 7 is an example showing the correspondence of the degree of similarity to brightness for face authentication. In FIG. 7, the vertical axis shows brightness of the environment in which a facial image is captured; and the horizontal axis shows the degree of similarity, which is a matching result of the image captured in the environment. Assume that the authentication process is started at Point a1, which represents an excessively high light intensity. The user realizes his/her facial image is not appropriately captured under this condition, and then, for example, lifts up a hand in front of his/her face to cast a shadow on the face, thereby reducing the light intensity. Herewith, the light intensity shifts to Points a2→a3→a4→a5. The authentication completes at Point a5. FIG. 8A shows examples of images captured at Points a1 through a5. FIG. 8A includes Image a1 in which facial characteristics are beyond all recognition; Image a2 in which the profile of the face can be partially recognized; Image a3 having a contrast problem; Image a4 that is still not fully sufficient for authentication; and Image a5 to be successfully authenticated since it exceeds the authentication threshold. In this case, by the process explained in FIG. 6, Images a1 through a5 are stored in the preliminary storage subunit 181. Also, among Images a2 through a5 having a degree of similarity reaching or exceeding the recognition threshold, one image determined by the user is additionally registered to the reference data storage subunit 182.

Similarly, assume that the authentication process is started at Point b1 of FIG. 7, which represents an excessively low light intensity. The user realizes his/her facial image is not appropriately captured under this condition, and then, for example, turns himself/herself around to change the body position or move to a well-lighted place. Herewith, the light intensity shifts to Points b2→b3→b4→b5. The authentication completes at Point b5. FIG. 8B shows examples of images captured at Points b1 through b5. FIG. 8B includes Image b1 in which facial characteristics are beyond all recognition; Image b2 in which the profile of the face can be partially recognized; Image b3 having a contrast problem; Image b4 that is still not fully sufficient for authentication; and Image b5 to be successfully authenticated since it exceeds the authentication threshold. In this case, by the process explained in FIG. 6, Images b1 through b5 are stored in the preliminary storage subunit 181. Also, among Images b2 through b5 having a degree of similarity reaching or exceeding the recognition threshold, one image determined by the user is additionally registered to the reference data storage subunit 182.

Accordingly, in either case (i.e. excessively high or low light intensity), if the authentication process takes place again in an environment similar to that in which the authentication process was previously carried out, the chances are high that the authentication would complete, requiring the authentication subject to make the same bodily adjustment as one made in the previous authentication process only for a shorter period of time. Furthermore, depending on circumstances, it is highly possible that the authentication would complete without requiring such a bodily adjustment, and it is less likely that the authentication subject is falsely rejected, or has to repeat the authentication process, taking a long time to complete the authentication. Particularly, if there is a change in the outdoor environment where the authentication process takes place, it is possible to dramatically speed up the authentication process. For example, if Image a3 of FIG. 8A is additionally registered as a piece of reference data, Image a2 is able to reach a degree of similarity reaching or exceeding the authentication threshold, and therefore the authentication can be completed. Similarly, for example, if Image b3 of FIG. 8B is additionally registered as a piece of reference data, Image b2 is able to reach a degree of similarity reaching or exceeding the authentication threshold, and therefore the authentication can be completed.

Also, even in an environment where according to conventional technology, the authentication threshold cannot be reached no matter what bodily movement the authentication subject makes, the present embodiment allows an additional registration of a piece of reference data which reflects and is therefore more closely related to the use environment of the authentication subject. As a result, the authentication is more likely to be completed.

CONCLUSION As has been described above, according to one embodiment of the present disclosure, pieces of authentication data during the authentication process are accumulated, and a piece of authentication data captured in the use environment of the authentication subject prior to completion of the authentication is added as a piece of reference data. As a result, without lowering the threshold of the degree of similarity, it is possible to improve the authentication accuracy subject to the authentication environment.

All examples and conditional language received herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A biometric authentication apparatus comprising:
an authentication data input unit configured to acquire a piece of authentication data from a biological object;
an authentication data process unit configured to accumulate one or more pieces of authentication data acquired from a start to an end of authentication;
a matching unit configured to successively match the accumulated pieces of authentication data against reference data, and complete the authentication when at least one of the accumulated pieces of authentication data has a degree of similarity with the reference data, in which the degree of similarity reaches or exceeds a predetermined authentication threshold; and
a reference data registration process unit configured to, in response to a detection that the authentication has completed after a predetermined period of time elapsed from the start of the authentication, make an additional registration in which, among the accumulated pieces of authentication data, one piece of authentication data whose degree of similarity reaches or exceeds a predetermined recognition threshold is additionally registered to the reference data.

2. The biometric authentication apparatus as claimed in claim 1, wherein the additional registration is made such that, among the accumulated pieces of authentication data, one piece of authentication data whose degree of similarity reaches or exceeds the predetermined recognition threshold and which has been determined by a user is additionally registered to the reference data.

3. The biometric authentication apparatus as claimed in claim 2, wherein the user determination is implemented by either specifying a time point prior to the completion of the authentication, which the time point corresponds to one of the accumulated pieces of authentication data, or selecting one from a list of the accumulated pieces of authentication data.

4. The biometric authentication apparatus as claimed in claim 1, wherein the authentication is determined as normal authentication if having completed within a predetermined period of time, and the authentication is determined as an authentication failure if having been terminated due to running out of a predetermined time-out period.

5. The biometric authentication apparatus as claimed in claim 1, further comprising:
an authentication data extraction unit configured to move the accumulated pieces of authentication data to a different data area for reuse.

6. The biometric authentication apparatus as claimed in claim 1, wherein the authentication data process unit deletes the accumulated pieces of authentication data after the end of the authentication.

7. A biometric authentication method comprising the steps of:
acquiring a piece of authentication data from a biological object;
accumulating one or more pieces of authentication data acquired from a start to an end of authentication;
successively matching the accumulated pieces of authentication data against reference data, and completing the authentication when at least one of the accumulated pieces of authentication data has a degree of similarity with the reference data, in which the degree of similarity reaches or exceeds a predetermined authentication threshold; and
in response to a detection that the authentication has completed after a predetermined period of time elapsed from the start of the authentication, making an additional registration in which, among the accumulated pieces of authentication data, one piece of authentication data whose degree of similarity reaches or exceeds a predetermined recognition threshold is additionally registered to the reference data.

8. The biometric authentication method as claimed in claim 7, wherein the additional registration is made such that, among the accumulated pieces of authentication data, one piece of authentication data whose degree of similarity reaches or exceeds the predetermined recognition threshold and which has been determined by a user is additionally registered to the reference data.

9. The biometric authentication method as claimed in claim 8, wherein the user determination is implemented by either specifying a time point prior to the completion of the authentication, which the time point corresponds to one of the accumulated pieces of authentication data, or selecting one from a list of the accumulated pieces of authentication data.

10. The biometric authentication method as claimed in claim 7, wherein the authentication is determined as normal authentication if having completed within a predetermined period of time, and the authentication is determined as an authentication failure if having been terminated due to running out of a predetermined time-out period.

11. The biometric authentication method as claimed in claim 7, further comprising a step of:
moving the accumulated pieces of authentication data to a different data area for reuse.

12. The biometric authentication method as claimed in claim 7, wherein the accumulated pieces of authentication data are deleted after the end of the authentication.

13. A biometric authentication control program for causing a computer to execute the steps of:
acquiring a piece of authentication data from a biological object;
accumulating one or more pieces of authentication data acquired from a start to an end of authentication;
successively matching the accumulated pieces of authentication data against reference data, and completing the authentication when at least one of the accumulated pieces of authentication data has a degree of similarity with the reference data, in which the degree of similarity reaches or exceeds a predetermined authentication threshold; and
in response to a detection that the authentication has completed after a predetermined period of time elapsed from the start of the authentication, making an additional registration in which, among the accumulated pieces of authentication data, one piece of authentication data whose degree of similarity reaches or exceeds a predetermined recognition threshold is additionally registered to the reference data.

14. The biometric authentication control program as claimed in claim 13, wherein the additional registration is made such that, among the accumulated pieces of authentication data, one piece of authentication data whose degree of similarity reaches or exceeds the predetermined recognition threshold and which has been determined by a user is additionally registered to the reference data.

15. The biometric authentication control program as claimed in claim 14, wherein the user determination is implemented by either specifying a time point prior to the completion of the authentication, which the time point corresponds to one of the accumulated pieces of authentication data, or selecting one from a list of the accumulated pieces of authentication data.

16. The biometric authentication control program as claimed in claim 13, wherein the authentication is determined as normal authentication if having completed within a predetermined period of time, and the authentication is determined as an authentication failure if having been terminated due to running out of a predetermined time-out period.

17. The biometric authentication control program as claimed in claim 13, further comprising a step of:
moving the accumulated pieces of authentication data to a different data area for reuse.

18. The biometric authentication control program as claimed in claim 13, wherein the accumulated pieces of authentication data are deleted after the end of the authentication.
